(19) United States
(12) Patent Application Publication
(10) Pub. No.: US 2024/0119432 A1
(43) Pub. Date: Apr. 11, 2024

(54) SYSTEM AND METHOD FOR MAKING A PHYSICAL DEPOSIT

(71) Applicant: Clip Money Inc., Toronto, Ontario (CA)

(72) Inventors: Joseph ABOU-ARRAGE, Toronto, Ontario (CA); Roger DALAL, Toronto, Ontario (CA); Daren TROUSDELL, Toronto, Ontario (CA)

(73) Assignee: Clip Money Inc., Toronto, Ontario (CA)

(21) Appl. No.: 18/276,296

(22) PCT Filed: Jan. 28, 2022
(86) PCT No.: PCT/CA2022/050114

§ 371 Date: Aug. 8, 2023

Related U.S. Application Data
(60) Provisional application No. 63/250,290, filed on Sep. 30, 2021.
(60) Provisional application No. 63/146,762, filed on Feb. 8, 2021.

(51) Int. Cl. G06Q 20/10; G06Q 20/32

(52) U.S. Cl. CPC G06Q 20/108; G06Q 20/3223

(57) ABSTRACT

The present invention relates to a system and method of making a physical deposit. There is provided a method of making a bank agnostic deposit comprising: receiving, by a deposit management platform, a request to make a deposit to a secure deposit hardware in communication with the deposit management platform, from a user; receiving, by the secure deposit hardware, the deposit from the user; confirming, by the secure deposit hardware, receipt of the deposit; sending, by the secure deposit hardware, confirmation of receipt of the deposit to the deposit management platform; sending, by deposit management platform, a notification to the user that the deposit was received, and initiating, by the deposit management platform, electronic transfer of funds corresponding to the deposit to the user or an electronic payment to one or more bank account(s) of the user.

### FIELD OF THE INVENTION

The present invention generally relates to a system and methods for making bank deposits. More particularly, the present invention relates to a bank agnostic system and methods for the handling and processing of bank deposits including, but not limited to cash, coin, and cheques.

### BACKGROUND OF THE INVENTION

Unlike digital transactions such as credit and debit card transactions, physical cash, coin, and cheque transactions are inconvenient to deposit, can be relatively slow, and are prone to human error. More particularly, after physical cash, coin, and/or cheques are received by a bank customer, the manners in which funds are counted, handled, processed, and ultimately deposited into a bank are cumbersome, not secure, and inefficient.

Bank customers often utilize night depositories to make deposits that are collected after the bank closes. Such depositories are limited to customers of the bank where the night depository is installed. In many cases the bank and/or night depository may be a fair distance from the customer's location. Customers of the bank input to the depository articles such as envelopes, bags or similar containers. The containers contain items for deposit such as checks, cash and credit slips and also generally contain a deposit slip to identify the entity making the deposit. Such deposits are typically hand-written and are manually calculated.

Users of a night depository place their deposits into the depository through an opening. Accessing the opening generally involves opening a door, slide or similar cover member. The secure depository includes a generally secure compartment. Deposited items are held in the secure compartment until an access door to the compartment is opened by an authorized person who has a lock combination, key or other suitable means for opening the secure compartment. The authorized person removes the deposited items. The items are then reviewed to determine what has been deposited and to verify that the deposited items conform with the associated deposit slip. Once the deposited items are counted and verified the appropriate account is credited.

One of the drawbacks associated with night depositories is that they provide no immediate record that the user has made the deposit. Disputes may arise between institutions which accept deposits and customers as to whether a deposit was made. When a deposit cannot be accounted for there is often a question as to whether an employee of the customer may have misappropriated the deposit. Or, there may be questions as to whether employees of the bank or third-party employees responsible for emptying the depository have misappropriated the deposit. In some cases such disputes are impossible to resolve. Additionally, deposits are not trackable or uniquely identified, making it impossible to know the state or possible location of a deposit at any given moment.

U.S. Pat. No. 8,496,167 teaches a method of verifying a deposit comprising providing a deposit bag with a radio frequency identification (“RFID”) tag secured to the deposit bag; reading the RFID tag by a safe antenna to verify that the deposit bag has been deposited into a safe; attempting to communicate with the RFID tag by the safe antenna at a predetermined time; and sending a signal that the deposit bag has been removed from the safe, if the RFID tag does not respond to the communication of the safe antenna.

U.S. Pat. No. 6,328,208 teaches a network connected night depository.

U.S. Pat. No. 9,495,705 teaches a process of facilitating cash collection deposits. The process utilizes a deposit ticket having a unique identification code associated therewith, the unique identification code being associated with the identified amount of collected cash.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and methods for making a physical deposit. In accordance with an aspect of the present invention, there is provided a method of making a bank agnostic deposit, the method comprising: receiving, by a deposit management platform configured to receive deposits from multiple unrelated business entities to any bank account, a request to make a trackable deposit from a user detailing the deposit total and denominations, including, but not limited to, cash, coin, and or cheque amounts along with a unique, trackable identifier assigned to said deposit; receiving, by secure deposit hardware configured to communicate with the deposit management platform, said deposit from said user utilizing trackable deposit bags and containers; confirming, by said secure deposit hardware, receipt of said deposit; sending, by said secure deposit hardware, electronic confirmation of the receipt of said deposit to said deposit management platform; optionally sending, by deposit management platform, a notification to said user that the deposit was received by said secure deposit hardware, and initiating, by said deposit management platform, an electronic transfer of funds corresponding to the deposit to said user or an electronic payment to one or more bank account(s) of said user.

In accordance with another aspect of the invention, there is provided a deposit management platform comprising a user experience layer; an operations layer, said operations layer comprising one or more transaction engines; and an integration layer.

In accordance with another aspect of the invention, there is provided a system comprising the deposit management platform of the invention in communication with one or more secure deposit boxes/cabinets.

### BRIEF DESCRIPTION OF THE FIGURES

FIG. 1 illustrates a user interface for creating a deposit using an embodiment of the present invention.

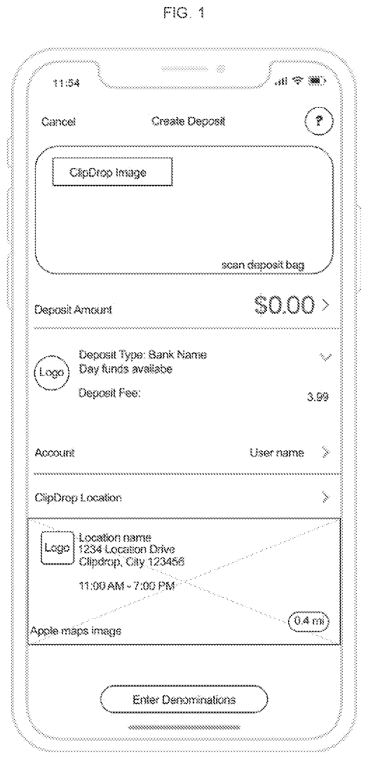

FIG. 2 illustrates a user interface for declaring amounts and currencies in a deposit using an embodiment of the present invention.

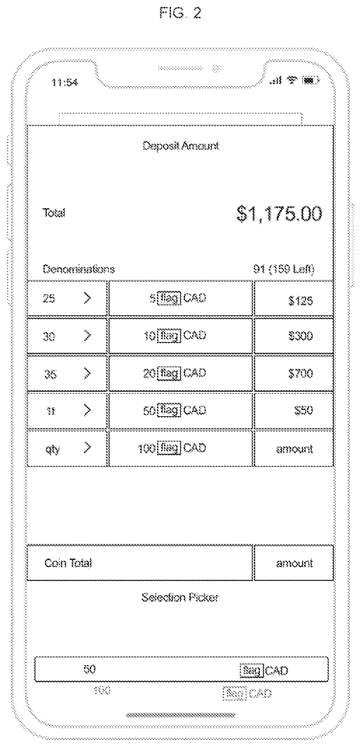

FIG. 3 illustrates a user interface for presenting the details of deposit using an embodiment of the present invention.

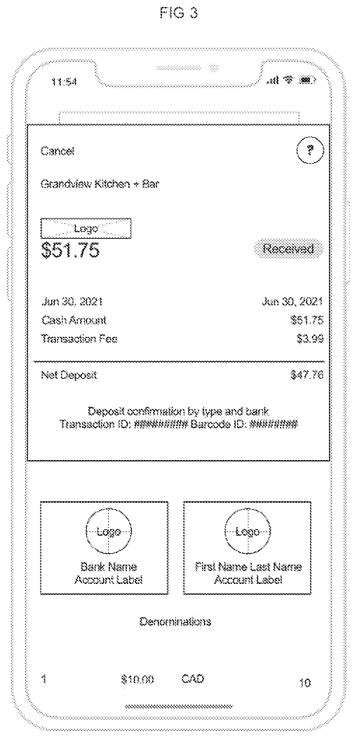

FIG. 4 illustrates a user interface for creating a business account using an embodiment of the present invention.

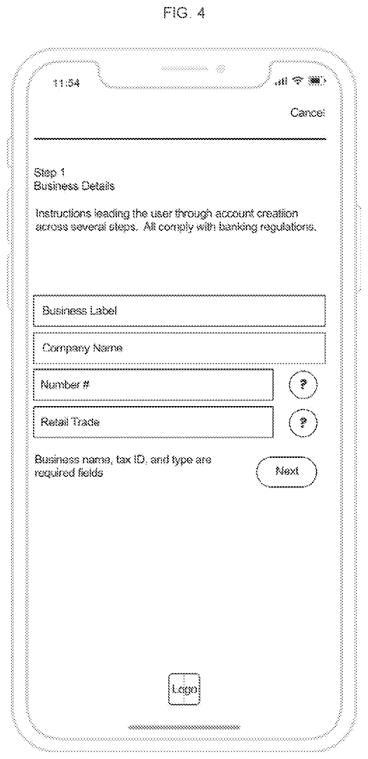

FIG. 5 illustrates a user interface for adding bank account details using an embodiment of the present invention.

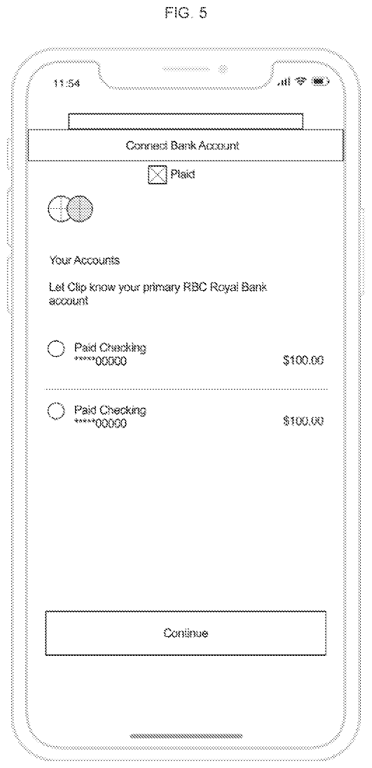

FIG. 6 illustrates a user interface presenting locations to make a deposit using an embodiment of the present invention.

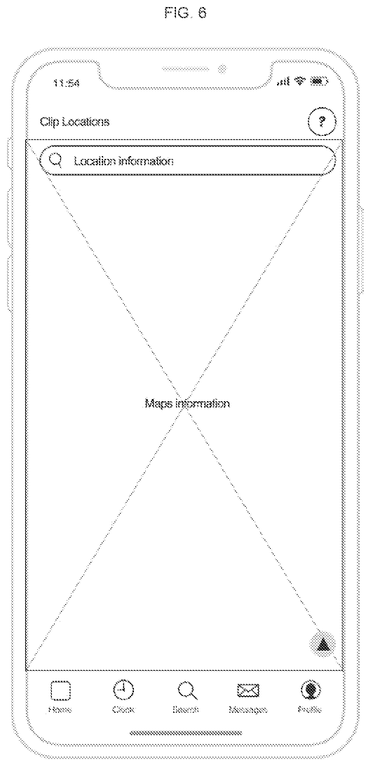

FIG. 7 illustrates a user interface presenting the details of specific location to make a deposit using an embodiment of the present invention

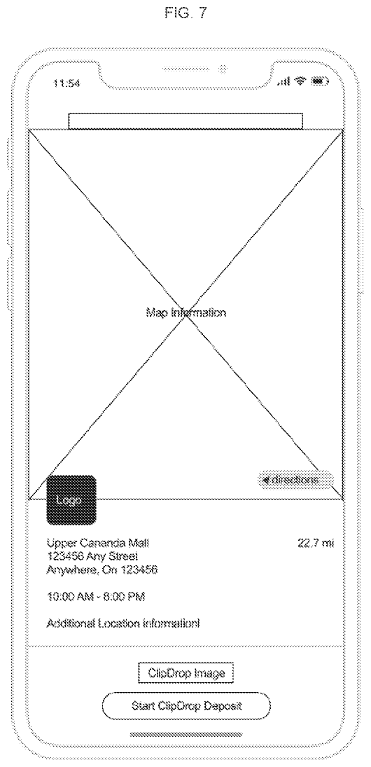

FIG. 8 illustrates a user interface presenting a history of deposits using an embodiment of the present invention

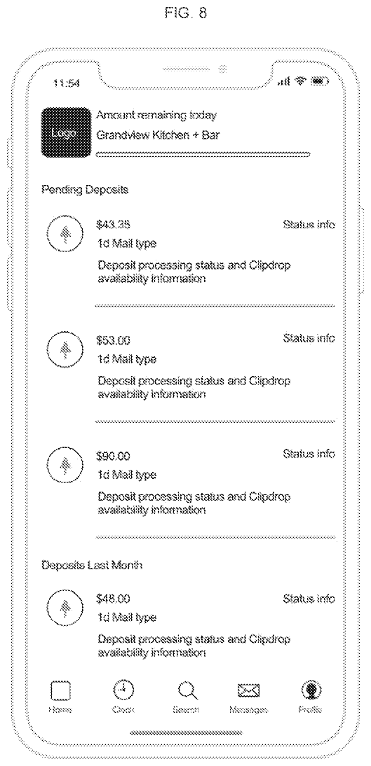

FIG. 9 illustrates an example of a physical deposit box used to receive deposits, which is an embodiment of the present invention.

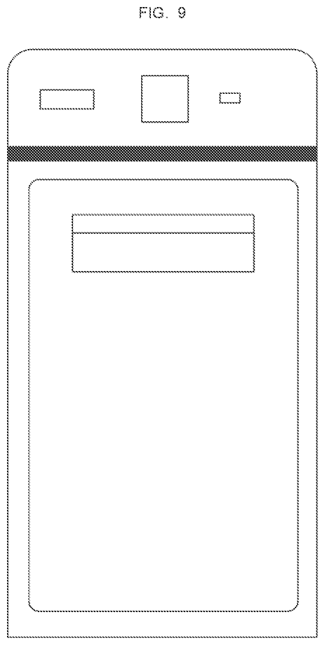

FIG. 10 illustrates an example of a physical deposit bag used for deposits, which is an embodiment of the present invention.

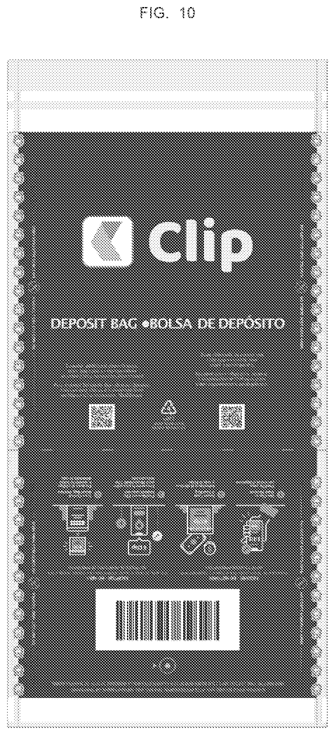

### DETAILED DESCRIPTION OF THE INVENTION

The present invention provides a system and method for making a physical deposit and the tracking of the deposits. As used herein, the system and method of the present invention may be used for any physical deposit including but not limited to cash (i.e. physical form of currency), coin, cheques, and other valuables such as precious metals. In certain embodiments, the system and method of the present invention is for deposits (such as cash, coin, and cheques) collected by a party, such as a retailer, during transactions for goods and/or services. In certain embodiments, the system of the present invention may provide one or more of the following advantages: reduce the cost and time associated with deposits, removes discrepancies common to handwritten deposit slips, reducing processing time and costs, improved cash flow; improved deposit security, improved convenience and access to deposit facilities or hardware; improved reporting regarding the state or location of a deposit due to trackable identifiers; and improved customer convenience.

The system and method of the present invention utilizes trackable deposit bags/container(s), internet-connected secured deposit box(es)/cabinet(s) and a deposit management platform or platforms to allow for the depositing, tracking, and processing of physical deposits.

### Method of Making a Deposit

In certain embodiments, is provided a method of making a bank agnostic deposit, the method comprising: receiving, by a deposit management platform configured to receive deposits from multiple unrelated business entities to any bank account, a request to make a trackable deposit from a user detailing the deposit total and denominations, including, but not limited to, cash, coin, and or cheque amounts along with a unique, trackable identifier assigned to said deposit; receiving, by secure deposit hardware configured to communicate with the deposit management platform, said deposit from said user utilizing trackable deposit bags and containers; confirming, by said secure deposit hardware, receipt of said deposit; sending, by said secure deposit hardware, electronic confirmation of the receipt of said deposit to said deposit management platform; optionally sending, by deposit management platform, a notification to said user that the deposit was received by said secure deposit hardware, and initiating, by said deposit management platform, an electronic transfer of funds corresponding to the deposit to said user or an electronic payment to one or more bank account(s) of said user.

In certain embodiments of the present invention, the steps for a deposit are as follows: a user states the amounts and denominations of the deposit using a system of the present invention; the user scans or enters the trackable deposit bag into the system of the present invention; the user inserts the deposit into the scanned trackable deposit bag; the user transports the scanned deposit bag to a secure deposit box/cabinet; opens the secure deposit box by, for example but not limited to, scanning or entering a code (in specific embodiments the code is on the deposit bag), and deposits the deposit bag into the secure deposit box. The secure deposit box confirms receipt of the deposit bag, for example by scanning for a tracking device, such as an RFID chip, in the bag and sends an electronic message that may include the unique deposit identifier to the deposit management platform that the deposit bag has been received. The deposit management platform then initiates the electronic transfer of funds to the user corresponding to the amount deposited. The electronic transfer of funds may be by any method known in the art including but not limited to e-transfer such as Interac e-transfer or direct deposit such as ACH direct deposit.

Receiving, by a deposit management platform, a request to make a cash deposit to a secure deposit box in communication with said deposit management platform, from a user.

The deposit management platform and secure deposit hardware are bank agnostic, and the deposit management platform and secure deposit hardware are configured to receive deposits from multiple entities, optionally unrelated business entities, to any bank account.

The request to make a deposit may be made by a user, or depositor authorized by the user, through a user interface or via a third party. The user interface may be a webpage and/or a software application. In certain embodiments, a user's computing device including but not limited to a computer, tablet or smartphone is used to access the user interface.

The request to make a deposit includes deposit information and user/depositor information. Deposit information may include, for example, a deposit bag identifier, total amount of the deposit, breakdown of the deposit including denominations and country of currency (i.e. banknotes and coins), and/or a list of cheques with optional cheque front and back images. User information making creating the deposit may include personal/business information, authorized depositors, bank account information, deposit preference, preferred communication and security questions/answers. The user information may be linked to a password accessible secure account or directly entered into a user interface.

In certain embodiments, the user inputs an identifier (may be a deposit bag identifier or a user identifier) in the user interface. In specific embodiments the user, or depositor authorized by the user, inputs the deposit bag/user identifier in the user interface by scanning the identifier. The identifier may be in the form of a code, such as an alphanumeric code, bar code or QR code, a RFID chip/tag or a Bluetooth (such as Bluetooth low energy (BLE) chip/tag, GPS chip/tag. In certain embodiments, the identifier is on or attached to the deposit bag. In certain embodiments, the deposit bag comprises an identifier code and a RFID chip/tag.

In certain embodiments, the user, or depositor authorized by the user, inputs the deposit amount and optionally denominations of paper currency, coins, and cheques in deposit in the user interface.

Receiving, by the secure deposit box, the deposit from said user.

The system of the present invention comprises one or more secure deposit boxes in communication with the deposit management platform. In certain embodiments, the user, or depositor authorized by the user, may use any available secure deposit box in the system. In other embodiments, the user may only use select deposit boxes in the system.

In certain embodiments, the status of the deposit box(es) (e.g. the deposit box is able to receive deposits, the deposit box is full; or unable to receive deposits) is determined, known and/or confirmed by the deposit management platform. For example, the deposit management platform may receive status updates from the deposit boxes in response to a request from the deposit management platform and/or as a result of a change in the status of the deposit box. Accordingly, in certain embodiments, prior to receiving the deposit, the method comprises confirming or determining, by the deposit management platform, the status of deposit boxes.

In certain embodiments, the system of the present invention may show the user the closest deposit box or boxes, and may present distances and/or provide directions on a map. In certain embodiments, a user might see all, or a subset of all, possible deposits boxes available in the deposit management platform.

In certain embodiments, the secure deposit boxes restrict access to the deposit input (e.g. deposit slot). For example, the secure deposit boxes may require a code to unlock the deposit input or may require the deposit bag to be scanned to unlock the deposit input. In certain embodiments, the user might unlock deposit boxes by inserting a magnetic card, or with a biometric scan, or by any other means as may be required to quickly and securely unlock the deposit input.

Confirming, by said secure deposit box, receipt of said deposit and sending, by the secure deposit box, confirmation of the receipt of said deposit to said deposit management platform.

Receipt of the deposit in the secure deposit box requires confirmation. This confirmation may be immediately following deposit or at predetermined intervals. In certain embodiments, the secure deposit box scans for the deposit bag tracking device in the secure holding area of the deposit box. In specific embodiments, the deposit bag has a RFID tag and the secure deposit box comprises a RFID reader which reads the RFID tag and sends the information on the RFID tag to the computing server device.

Optionally, a notification to said user that the deposit was received.

In certain embodiments, a notification is sent to the user that the deposit was received by the secure deposit box. The notification may be in the form of an in-app notification, banner, email, instant message (im) and/or text message (i.e. sms and mms). In certain embodiments, notifications might be sent to other users or third-parties as designated by persons or parties authorized to designate such users or third-parties.

Initiating electronic transfer of funds corresponding to the deposit to said user or said user's account.

The deposit management platform processes the deposit transaction and then initiates a transfer of funds corresponding to the amount deposited to the user through an electronic funds request to one or more financial institutions. In certain embodiments, the electronic transfer of funds occurs prior to the contents of the deposit bag being confirmed physically. In certain embodiments, the electronic transfer of funds occurs after the contents of the deposit bag has been confirmed physically. The electronic transfer of funds may be by any method known in the art including but not limited to e-transfer such as Interac e-transfer or direct deposit such as ACH direct deposit.

In certain embodiments, the method of the present invention further comprises automatically initiating a reconciliation process to confirm that the physical deposit corresponds to the deposit amount noted in the request. In certain embodiments, the deposit management platform receives verification of deposit amount from the party counting the physical deposit.

In certain embodiments, the deposit management platform sends a notification once the deposit has been physically counted and discrepancies, if any, are noted. The notification may be in the form of an in-app notification, banner, email, instant message (im) and text messaging (i.e. sms and mms).

In certain embodiments, a predetermined amount of time (e.g. 24 hours) is set as a dispute period. In certain embodiments, the reconciliation process includes review of processor evidence including CCTV footage and audit logs.

In certain embodiments, the method of the present invention further comprises sending data to third parties, such as the bank to which the user wishes to make the deposit to. The data may be sent to third parties as required through secured API's, FTP upload, web dashboards, etc. The data may include but is not limited to customer details, deposit value, deposit breakdown—detail of notes, coins and cheques, deposit location, employee who made the deposit, timestamp and adjustment and reconcilement file.

### Method of Transaction Monitoring

In certain embodiments, the present invention provides a method of transaction monitoring. In certain embodiments, the method is a real-time method of transaction monitoring. In certain embodiments, transaction monitoring checks velocity, frequency, and/or deposit amounts across customers, locations, and network partners in real time. In particular, the method comprises comparing one or more transaction parameters to one or more standards and/or one or more comparator parameters such as past transaction parameters of the user, and automatically triggering downstream processes including but not limited to triggering an alert if the monitored transaction parameters are different from the standard or comparator parameters. For example, if a user makes a deposit which is more than double the amount of the deposits that the user typically makes or if a user makes multiple deposits at deposit boxes located at different locations at the same time, downstream processes may be triggered. Such downstream processes may include for example, sending an alert (e.g. sms, im or text), placing a hold on the electronic transfer of funds.

In certain embodiments, there is provided various interfaces that display a real-time listing of all or a selection of deposits. In certain embodiments, a user can print or send printed or digital reports of all or a selection of deposits.

### System:

The system comprises a deposit management platform in communication with one or more secure deposit boxes/cabinets.

In certain embodiments, the deposit management platform comprises a UX (i.e. user experience layer); operations layer and integration layer.

The user experience layer comprises a user interface that may be configured for self service or teller/over the counter (OTC) service. In certain embodiments, the user experience layer further provides one or more of the following: location services, notifications, customer support, user management, codes and loyalty.

The operations layer comprises one or more engines to automate one or more of the following settlement, risk/AML, reporting, dispute management, security, payment processing and cash management.

The integration layer provides an application programing interface allowing communication with one or more applications or services including but not limited to core and mobile banking, payment gateways or networks, accounting, POS, CRM and data management. In certain embodiments, the platform of the present invention integrates with mobile banking applications.

### Deposit Box

The system of the present invention comprises one or more secure deposit boxes which are communication with the deposit management platform. The secure deposit boxes comprise one or more means for network connectivity and one or more sensors. In certain embodiments, the secure deposit boxes comprise one or more means for internet connectivity. In certain embodiments, the secure deposit boxes have cellular connectivity. In specific embodiments, the secure deposit boxes have high speed cellular connectivity. In certain embodiments, the secure deposit boxes have ethernet connectivity. In certain embodiments, the secure deposit boxes have cellular and ethernet connectivity.

In certain embodiments, the secure deposit boxes have one or more sensors. The sensors may include a code reader such as a barcode or QR code reader and a RFID reader. In certain embodiments, the secure deposit boxes comprise a code scanner and RFID reader. In such embodiments, the code scanner allows for clear change of custody from the user/depositor to the deposit box and the RFID reader provides confirmation that the deposit bag has been deposited.

In certain embodiments, communications to and from said secure deposit box are encrypted.

In certain embodiments, the deposit box sends status updates to the deposit management platform. The deposit box may be emptied on a regularly scheduled basis or in response to a notification from the deposit box that it requires emptying or a service. In certain embodiments, the deposit management platform interfaces with third party system overseeing collection of physical deposits from deposit box.

Materials for construction of the deposit boxes are known in the art and include steel. A worker skilled in the art would readily understand the security considerations when installing such deposit boxes. For example, such a worker could readily determine appropriate locations and appreciate that such boxes should be secured, for example secured to a floor using bank/industrial grade anchors. In certain embodiments, the deposit box comprises a user interface or video display. The display may be used to provide information and/or advertising.

### Deposit Bag:

The deposit bags for use with the system and method of the present invention are trackable. In certain embodiments, a tracker is attached to a conventional deposit bag. The tracker may be in the form of a tag for attachment to a conventional deposit bag. In certain embodiments, the tracker is a RFID chip or tag.

In certain embodiments, the deposit bag further comprises an identifier code, such as a bar code or QR code.

In alternative embodiments, the tracker is embedded in the bag. In certain embodiments, the tracker is a RFID tag. In certain embodiments, the deposit bag comprises a code such as a bar code or QR code and a RFID chip/tag.

We claim:

1. A method of making a bank agnostic deposit, the method comprising:
receiving, by a deposit management platform, a request to make a deposit to a secure deposit hardware in communication with said deposit management platform, from a user, wherein said deposit management platform and secure deposit hardware are bank agnostic, and wherein said deposit management platform and secure deposit hardware are configured to receive deposits from multiple entities, optionally unrelated business entities;
receiving, by the secure deposit hardware, said deposit from said user;
confirming, by said secure deposit hardware, receipt of said deposit;
sending, by said secure deposit hardware, confirmation of the receipt of said deposit to said deposit management platform;
sending, by deposit management platform, a notification to said user that the deposit was received by said secure deposit hardware, and
initiating, by said deposit management platform, electronic transfer of funds corresponding to the deposit to said user or an electronic payment to one or more bank account(s) of said user.

2. A deposit management platform comprising a user experience layer; an operations layer, said operations layer comprising one or more transaction engines; and an integration layer.

3. A system comprises the deposit management platform of claim 2 in communication with one or more secure deposit boxes/cabinets.
